(19) United States
(12) Patent Application Publication
(10) Pub. No.: US 2021/0400925 A1
(43) Pub. Date: Dec. 30, 2021

(54) BEEHIVE

(71) Applicant: Hyper Hyve LLC, River Falls, WI (US)

(72) Inventor: Michael James HARVEY, River Falls, WI (US)

(21) Appl. No.: 17/354,886

(22) Filed: Jun. 22, 2021

Related U.S. Application Data
(60) Provisional application No. 63/044,612, filed on Jun. 26, 2020.

(51) Int. Cl. A01K 47/06

(52) U.S. Cl. CPC A01K 47/06

(57) ABSTRACT

An insulated honeybee hive assembly with an integrated monitoring system, the system including software and wiring contained in a wall assembly of the modular hive. The system includes sensors and other device(s) for monitoring temperature, humidity, weight, geographical location, and power generation of the hive. The system also includes a video and/or audio component, with connectivity to remote server(s), that allows for remote data collection, video and/or audio analysis and can provide hive command(s) such as heat treatments, ventilation, and similar. Sensors, wiring, buses, and other hardware are confined within the wall assemblies of the hive box and connect to one another once stacked upon each other.

### CROSS-REFERENCE

The present application claims priority to U.S. provisional application 63/044,612 filed Jun. 26, 2020 titled BEE HIVE, the entire disclosure of which is incorporated herein by reference for all purposes.

### BACKGROUND

Bees play a vital role in our food system. In addition to pollinating flowers, honeybees and other flying insects are responsible for pollinating fruits and vegetables, a significant amount of the world's food supply. Without bees, as much as ⅓ of the food available for humans in the world could be lost.

Beekeepers around the world are seeing up to 40% bee losses during an average winter. These loses are due to many factors, including Colony Collapse Disorder (CCD), which can be brought on by the stresses from, e.g., varroa mites, inadequate foraging due to lack of habitat, and other immune-suppressing stressors. Beekeepers also lose many bees due to unpredicted swarming.

While there may be some existing strategies outside of treatment and direction for CCD, monitoring a hive and/or providing a less stressful environment for the bees to live in is critical to helping reduce CCD.

### SUMMARY

The present disclosure is directed to an insulated beehive assembly (e.g., honeybee hive assembly) having a comprehensive, integrated environmental monitoring system, the system including various sensors, wiring, and processors contained in a wall assembly of the modular hive. The monitoring system includes sensors and other device(s) for monitoring any or all of temperature, humidity, weight of hive, weight of frame(s), geographical location and change thereof, and power generation of the hive. The monitoring system can also include video and/or audio components and/or motion sensors.

The beehive assembly is composed of multiple components, including a bottom or base section, at least one box, and a roof section. The sensors, wiring, and other hardware are confined within the walls of the components, which connect to one another once stacked upon each other. Electrical connection between the components is by buses, also confined within the walls.

The beehive assembly has connectivity to remote server(s), that allows for remote data collection and analysis of that data to provide command(s) or instructions to the hive, such as to initiate heat treatments, increase ventilation, and the like. Ongoing analysis of the data can be used to provide predictions of future hive events (e.g., swarms).

In one particular implementation, this disclosure provides an insulated beehive assembly having a base section, at least one box, and a roof section, with each of the base section, the at least one box, and the roof section are stackable to provide the hive. Each of the base section, the at least one box, and the roof section has a wall assembly construction comprising walls and insulation between the walls, the wall assembly construction having an R-rating of at least 4. The beehive assembly further has a monitoring system within the wall assembly construction of at least one of the base section, the at least one box, and the roof section, the monitoring system comprising at least a humidity sensor, a temperature sensor, a wireless communication receiver and a wireless communication transmitter. The beehive assembly also includes a power source operably connected to the monitoring system.

These and other aspects of the beehive assembly and beehive system described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE FIGURES

FIG. 1 is an exploded perspective view of a beehive assembly having two boxes, a roof and a base.

FIG. 2 is a schematic cross-sectional side view of two example wall constructions.

FIG. 3 is an exploded perspective view of a beehive assembly illustrating sensor placement.

FIG. 4 is a schematic diagram of a system incorporating three shown beehive assemblies with appropriate electronics.

### DETAILED DESCRIPTION

As indicated above, this disclosure is directed to an insulated beehive assembly composed of at least a bottom or base section, at least one box, and a roof section, the assembly having a comprehensive, integrated environmental monitoring system at least partially contained in a wall assembly of the modular hive. The monitoring system includes sensors and other device(s) for monitoring any or all of temperature, humidity, carbon dioxide, VOCs, weight of hive, weight of frame(s), geographical location and change thereof, power generation of the hive, and bee activity and movement into, out from, and inside the hive. The beehive assembly can be part of a system that includes connectivity to remote server(s) that allows for remote data collection and analysis of that data. A system can include multiple beehive assemblies. The beehive assembly and the system are a great aid to decreasing bee losses, such as due to Colony Collapse Disorder (CCD) and other stresses.

Most current beekeepers are managing bees in box designs similar to what was originally created by Lorenzo Lorraine Langstroth and patented in 1852; this design has not changed much over 175 years. The Langstroth hive, with a commonly used ¾″ pine board for the sides and top cover, has an insulation value of approximately 0.75-R. With today's challenges of CCD, bees and beekeepers are struggling to keep bees through winter all around the world.

Honeybees have evolved in nature to dwell primarily in hollowed out trees, such as oak trees, with a typical side wall thickness of 4-5″ and a very thick ceiling extending to the top of the tree. A tree helps provide a stable colony temperature in the cold winter months as well as during hot summer months. Hives attempt to maintain a hive temperature in spring through late summer at 95° F. to keep the brood alive and honey just right. Bees do not hibernate. In winter, the hive maintains a temperature within the hive of 81° F. in the center of the cluster and 55° F. on the outer sides of that cluster; this is even in temperatures that can exceed −40° F. in cold climates.

Some beekeepers, both backyard and commercial, use some type of monitoring to track their hives year-round. There are a few add-on or retrofit products trying to solve the problems with hives through data collection from sensors, counters, sound recording devices, lasers for mites, and similar. For example, some products include integrated weather, temperature, humidity, and weight monitoring (see, e.g., U.S. Pat. No. 6,910,941 B2; US 2017/0360010 A1; WO 2015/048308 A1) and counting bees (e.g., U.S. Pat. No. 10,064,395 B2); these are good ways to get early detection to colony losses and stresses. These products do help beekeepers track hives, but these systems have sensors powered by batteries, externally positioned cords or wires, and various sensors and control wires hanging in, around and outside of the hive. However, these expensive product add-ons create their own challenges, including difficult or improper set-up of the product, increasing labor time, improper use, and the like.

The beehive assembly of this disclosure solves the fundamental issue of a better insulated box to help any compromised bee colonies through the winter as well as keeping them cooler in the summer months, helping them regulate their temperature better. By having the bees regulate themselves better, it conserves the bees' fuel stores (helping conserve energy and food reserves) to get them through tougher winters and hotter summers.

The beehive system of this disclosure allows beekeepers to remotely monitor the health of the hive without cumbersome wires, sensors, and other monitoring devices that utilize devices or wires present inside or outside the hive box, which often require extra labor when inspecting or setting up a hive and which can be damaged by, e.g., weather or predators (e.g., bears). The data from monitoring the hive allows manual or automatic adjustment of hive conditions. The monitoring allows beekeepers to know when to physically check a hive.

The beehive assembly of this disclosure also incorporates an on-hive power generation system; this reduces manual battery level inspections, saving the beekeeper time and labor and fuel costs.

Overall, the beehive assembly of this disclosure mimics the classical “honey tree” in which the honeybee evolved to survive. The assembly is an insulated hive, with a wall assembly configured to integrally accommodate technical monitoring devices, as part of a system that includes computer hardware and software, and may have at least one of each but not limited to a microprocessor, microcontroller, integrated microcomputer, memory, integrated wiring, integrated power generation, power storage, integrated sensors, GPS, load cells or similar, machine learning camera, and various input and output communication devices.

The hive assembly has components that are stackable and self-sealing with gaskets. The components are well insulated with an insulative material; for example, foam or fiberglass incapsulated within a building material such as wood, plastic, fiberglass or a composite material. Present with the walls of the hive, either between or within the insulation material, are the wires, buses, sensors, output devices, communication devices, box to box connection devices, box to frame connection devices, power supply, power supply lines, and other components of the monitoring system.

In the following description, reference is made to the accompanying drawing that forms a part hereof and in which is shown by way of illustration at least one specific implementation. The following description provides additional specific implementations. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

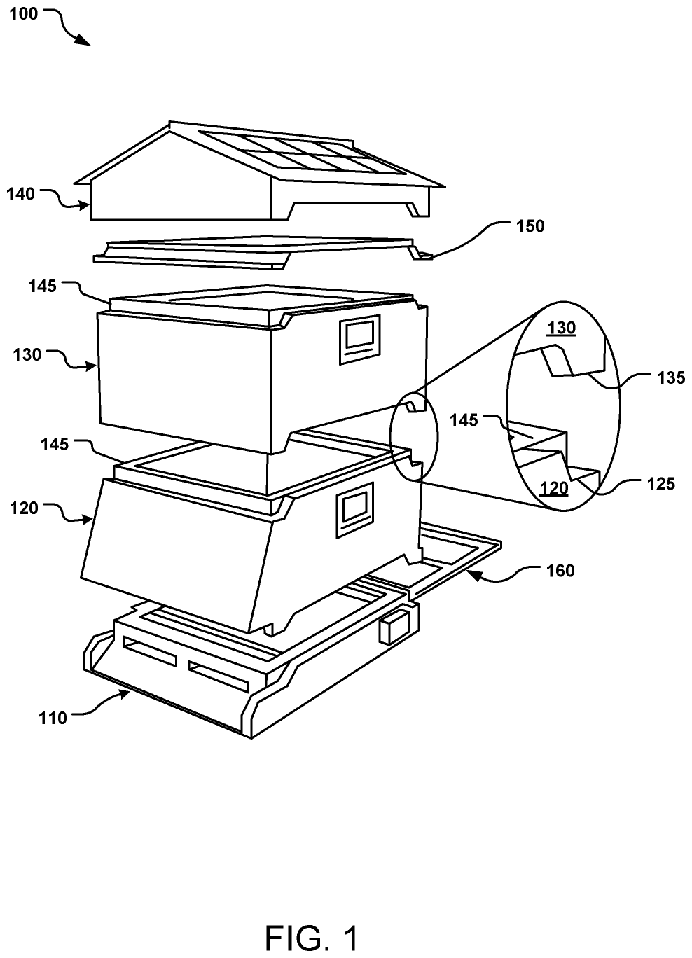

FIG. 1 illustrates a beehive assembly 100 with a base 110, a first box 120 (e.g., a brood box), a second box 130 (e.g., a honey super), and a roof structure 140. Also shown in this assembly 100 is an inner cover 150 and a heating pad 160. Of course, other structures, such as a Queen excluder could be present. The boxes 120, 130 have insulated walls, having an insulative R-value of at least 4, in some implementations at least R-6, and in other implementations at least R-10. The roof structure 140 may also be insulated with an R-value of at least 4 or at least R-6 or at least R-10.

The hive assembly 100 is similar to a Langstroth hive; the assembly 100 is modular and composed of components that can be interchangeably stacked on top of each other. The interchangeable components provide flexibility to the beekeeper to use to components (e.g., brood boxes, honey boxes, queen extruders, etc.) as needed and as desired. Any number of second boxes 130 can be added to increase the brood boxes or the honey boxes, as described. The stacked components (e.g., the base 110, the first box 120, the second box 130, the roof structure 140, and the inner cover 150) are electrically connected through embedded connection points, as described below.

On the bottom is the base 110, which sits on the ground or elevated, e.g., on a small table or blocks or with built-in elevating legs. The base 110 is insulated on the bottom sides and back, leaving an opening (e.g., an adjustable slot) for bees to enter and exit the assembly 100.

The boxes 120, 130 can be, e.g., brood boxes or honey boxes, either of which can be referred to as “supers.” The boxes 120, 130 can be made of weather resistant material and are insulated between the exterior and interior walls of the boxes.

Depending on the beekeeper's preference, one or more brood boxes may be used. Honey boxes, honey supers, or just supers, are present on top of the brood boxes and their main function is to act as honey collectors. Both the brood boxes and honey boxes contain frames with honeycomb. In the honey boxes, honey is collected in the cells of the honeycomb, whereas in brood boxes, new bees (brood) are raised.

Although additional details are provided below, the boxes 120, 130 contain within the wall assembly at least some component from the monitoring system of the assembly 100, such as a microcontroller, a microprocessor, sensors, batteries, controllers, servos, communication equipment that aids in the management of and passing of information to a beekeeper onsite and/or offsite, etc. The boxes 120, 130 are electrically connected via press-fit or pressure connectors or buses. The boxes 120, 130 have a gasket system to inhibit air infiltration between the joints between stacked boxes. In other implementations, the boxes 120, 130 or other components may merely have overlapping engagement (e.g., a step or shoulder) to inhibit air flow therebetween.

The roof structure 140 provides a water and weather proof top to the beehive assembly 100. Although shown as angled in FIG. 1, in some designs the roof structure is flat. The roof structure 140 is insulated to help control the heat and/or cold transfer from the interior of the assembly 100 to the exterior. The roof structure 140 may also contain a gasket system to inhibit air infiltration; however, in some implementations, may not, as the gasket from the box immediately below the roof structure 140 provides the sealing. The roof structure 140 may also include a manual or remote-controlled damper system, to inhibit moisture buildup, e.g., due to dew point. The roof structure 140 can have a power generation unit that may be powered by photovoltaics or similar, controlled by a charge controller. This energy then can be stored in a battery, in any of the assembly components, or within the roof assembly itself

The roof structure 140 also contains monitoring system components, such as control circuits, monitoring circuits or sensors, or other devices of the monitoring system and/or communication devices which may be routed through a buss system at least partially present in the insulation or other parts of the hive walls; the roof structure 140 may also have a microcontroller, GPS, microprocessor, router or similar. All of these devices may have the ability to directly communicate through a buss system connected via connectors between each assembly component. There may additionally or alternately be wireless transmission between components and, e.g., a server, “The Cloud” or Internet of Things (IOT).

The heating pad 160 can also be referred to as a hyperthermia board, which is installed adjacent to the base 110 and is used for heating the interior of the hive assembly for treating against Varroa Destructor (e.g., heating the hive to 105° F. for 3 hours, or 107° F. for 2 hours). In some designs, a fan or other air movement equipment may be incorporated into the heating pad 160.

Referring to the first box 120 and the second box 130 shown in the enlarged insert, the components (e.g., the first box 120 and the second box 130) stack in a mating configuration and can have features to aid in their alignment. The (lower) box 120 has a recess 125 to receive a tab 135 from the (upper) box 130; in other implementations, the lower box can have the tab and the upper box can have the recess to receive the tab. The mating features (e.g., the recess 125 and the tab 135) are positioned at each corner of the boxes 120, 130, although in other implementations the mating features may extend the entire length of the box, or, may be present at less than all the corners. The recess 125 and the tab 135 provide a self-seating connection that facilitates proper lineup of electrical connections and such between the boxes 120, 130. These mating features can be present at any joint between two components of the assembly 100.

Present around the top end of a component (e.g., the base 110, the first box 120, the second box 130) is a gasket 145 to improve sealing between the components. The gasket 145 is present at the top of the wall assembly, around the top perimeter of the component (e.g., the base 110, the first box 120, the second box 130). In some implementations, a gasket may be additionally or alternately present at the bottom or base end of a component. The gasket 145 inhibits air flow into and out from the interior of the assembly 100 through the joints. The gasket 145 can be, e.g., rubber, polyurethane, or isocyanate.

It is noted that in the particular assembly 100 shown, the components are not fully interchangeable in their position. For example, the roof structure 140 is the top-most structure in the assembly 100 and cannot have another component stacked thereupon. Also, the first box 120 has a base (footprint) dimension greater than that of the second box 130 and is configured to engage or mate with the base 110. The second box 130 is not able to be stacked directly onto the base 110 because it has smaller (footprint) dimensions than the base 110 and the mating features will not align. Additionally, the first box 120 cannot be stacked on the second box 130; again, because of the different footprint dimensions the mating features will not align. In other designs of the beehive assembly, various components may be completely interchangeable (e.g., all the components have the same dimensions so that the base 110 is sized to receive any component). In yet other designs, the mating features can be positioned to allow interchangeable stacking of the components no matter the component dimensions.

It is also noted that any number of additional components (e.g., boxes 120, 130) can be added as needed. Additionally, other components not described herein, such as but not limited to feeders, bottom boards, lids, top covers, inner covers, pollen collectors, and such could be added to and incorporated into the hive assembly 100.

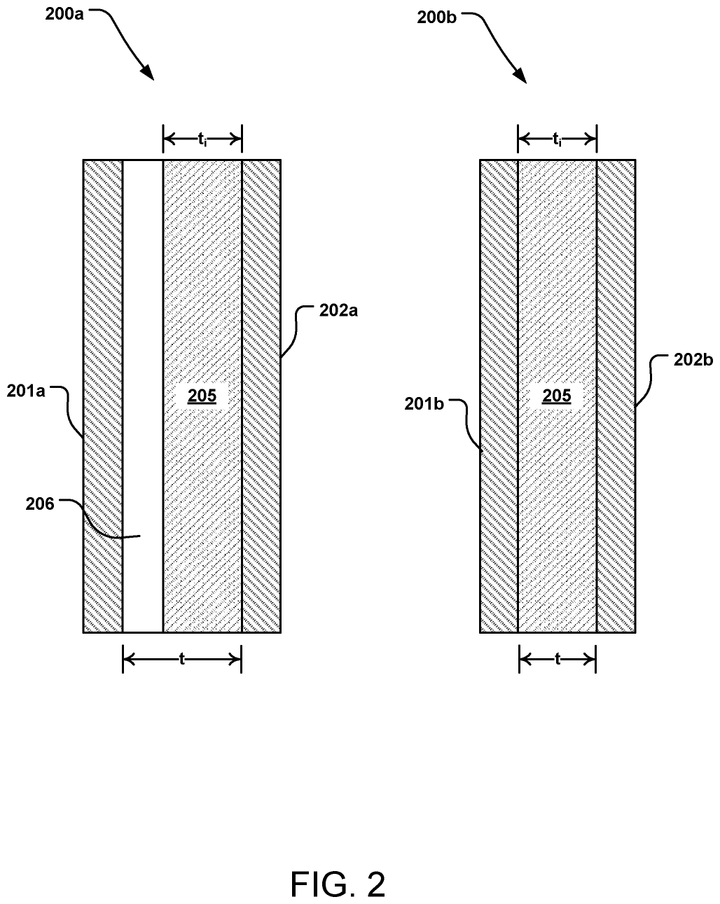

FIG. 2 shows two internal cross-sections of wall assemblies for the boxes; two wall assemblies 200a, 200b are shown. Each wall assembly 200a, 200b has a first wall 201a, 201b (respectively) and a second wall 202a, 202b (respectively); either of the walls 201, 202 may be an interior wall or an exterior wall. The walls 201, 202 may be, e.g., wood, plastic, fiberglass, metal, or other building materials; the two walls 201, 202 may be the same or different material. This thickness of the walls 201, 202 should be sufficient to provide structural rigidity to the box while balancing weight of the box. In some implementations, the outer wall (which ever wall 201, 202 that may be) has an outer surface that is weatherproof or weather resistant. Also in some other implementations, the inner wall (which ever wall 201, 202 that may be) has an outer surface, the surface being exposed to the interior of the hive and the bees, that has a roughened texture.

Present between the walls 201, 202 is an insulating material 205. The insulating material preferably extends the full height of the wall constructions 200. In the first wall construction 200a, the insulating material 205 does not fill the entire thickness “t” of the construction 200a between the walls 201a, 202a, but rather, a void area 206 is present; the insulating material 205 has a thickness “tᵢ” that is less than the thickness “t”. In the second wall construction 200b, the insulating material 205 has a thickness “ti” that does fill the entire thickness of the construction 200b from the first wall 201b to the second wall 202b, so that the thickness “ti” is the same as the thickness “t”.

The insulating material 205 can be foam (e.g., open cell, closed cell, polyurethane, isocyanate, polycarbonate), extruded or expanded foam board (e.g., polystyrene, isocyanate), fiberglass, or other insulating material having an R-rating of at least 1 and an overall rating of at least R-4 for the wall construction 200, often at least R-6.

Present within the wall construction 200, between the walls 201, 202, are various components of the monitoring system, which includes communication components, of the beehive assembly 100. The components may be embedded in the insulating material 205, however, if the void 206 is present in the wall construction, some or all of the component(s) can partially or fully be present in the void 206.

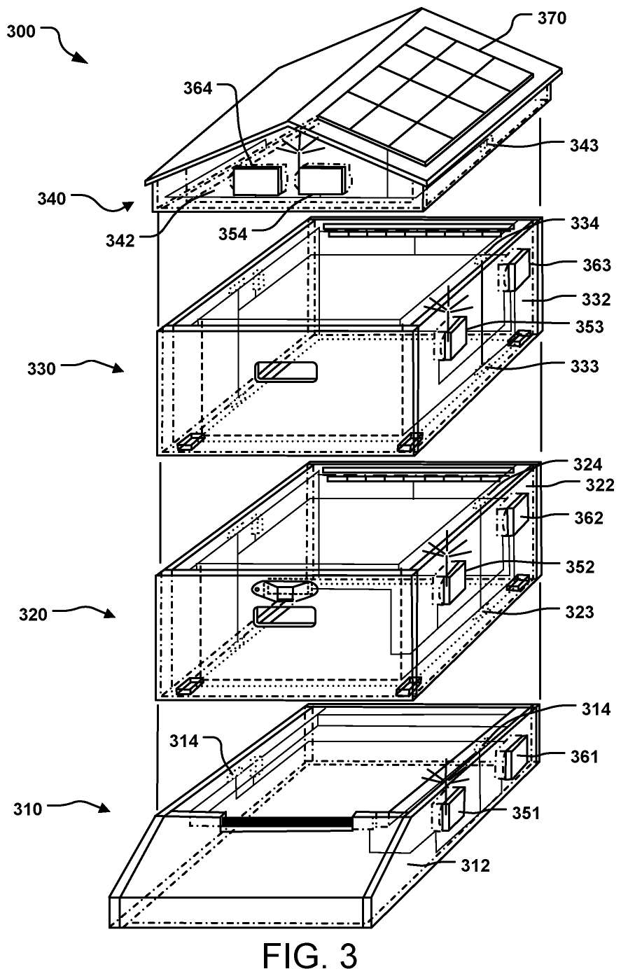

FIG. 3 shows how system components such as wires, buses, sensors, etc. interact and how they are embedded within the walls of the assembly components. FIG. 3 shows a beehive assembly 300 with a base 310, a first box 320 (e.g., a brood box), a second box 330 (e.g., a honey super), and a roof structure 340. As described above with respect to FIG. 1, the components (e.g., the base 310, the boxes 320, 330, and the roof structure 340) are removably stackable; in this shown system 300, the boxes 320, 330 are interchangeable, as they both have the same footprint dimensions. Present in the wall assemblies of the components are any or all of a microcontroller, microprocessor, sensors, batteries, controllers, thermometers, heating devices, servos, and wireless data communication devices.

As seen in the figure, the base 310 has a commonly known structure, including an access for bees to enter and exit from the interior of the assembly 300. Although not shown, the access can be adjusted, as needed based on the temperature and/or humidity in the assembly; the adjustment may be manual (e.g., by the beekeeper) or may be automatic, such as by servo motors built into the base 310. The base 310 has insulated wall assemblies 312, at least one of which includes monitoring components therein. Additionally, the base itself (i.e., the horizontal base) can be insulated.

The base 310 has a transmitter/receiver 351 and a temperature/humidity sensor 361. The base 310 also may have a load cell or scale incorporated into it, e.g., at the very bottom, in order to weight the total hive assembly 300; with weight information, the beekeeper can monitor the amount of honey being collected in the hive or the number of bees present in the hive. The base 310 also includes a connecting buss 314 present at a top edge of at least one wall assembly 312.

The box 320 also has a commonly known structure, similar to a Langstroth box. The box 320 has insulated wall assemblies 322, at least one of which includes monitoring components therein. The box 320 has a transmitter/receiver 352 and a temperature/humidity sensor 362. The box 320 also includes connecting buses 323 present at a bottom edge of at least one wall assembly 322 and connecting buses 324 present at a top edge of at least one wall assembly 322. Similarly, the box 330 has insulated wall assemblies 332, at least one of which includes monitoring components therein. The box 330 has a transmitter/receiver 353 and a temperature/humidity sensor 363. The box 330 also includes connecting buses 333 present at a bottom edge of at least one wall assembly 332 and connecting buses 334 present at a top edge of at least one wall assembly 332. The boxes 320, 330 are essentially interchangeable.

The roof structure 340 has a commonly known structure and may be sloped (as shown) or flat. The roof structure 340 has insulated wall assemblies 342, including the roof panels, at least one of which includes monitoring components therein. The roof structure 340 has a transmitter/receiver 354 and a temperature/humidity sensor 364. The roof structure 340 also includes connecting buses 343 present at a bottom edge of at least one wall assembly 342. A solar panel 370 on the roof panel provides the hive assembly 300 to generate electricity, e.g., to operate the monitoring components. Additionally, or alternately, other power generation units, such as a windmill or wind generator, may be operably connected to the roof structure 340 or otherwise connected to the hive assembly 300.

An electrical storage device (e.g., battery) may be integrated into the assembly 300 or may be present external to the assembly 300 and connected thereto by wires, to store the energy (e.g., electricity) produced by any power generation units. Each component of the hive assembly 300 (e.g., the base 310, the boxes 320, 330, and the roof structure 340) may have a battery for any of its monitoring components needing power or the assembly 300 may have one battery for the entire hive assembly 300.

As explained above, the hive assembly 300 has components of the monitoring system located within the wall assemblies of the hive components. Components that may need inspection or occasional replacement may have access panels, covers, doors, or similar to egresses in the wall assemblies to gain access to such components.

Shown in FIG. 3 are temperature and humidity sensors (it is understood that one or two separate devices may be used) and transmitter/receivers to send data collected from the components (e.g., temperature data, humidity data) to a remote location. Not illustrated in FIG. 3 but understood to be present, are appropriate computer processors or microprocessors, controllers, and/or memory. Other sensors, such as a carbon dioxide sensor or a VOC sensor may additional be present. A GPS unit and/or accelerometer may be present in one or all of the components, e.g., to track movement of the component. Additionally, an RFID identification chip may be present in one or all of the components, e.g., to provide identification of the component. Proximate any entrances into the hive assembly can be a camera or other video apparatus, mounted internally in the hive, external to the hive, or integrated into a hive component. A separate microphone may be present or one may be integrated with the video. The hive assembly 300 can utilize machine learning or AI to analyze bee movement around the hive entrances or other locations.

Data from the sensors and other monitoring components may be saved to memory or may be immediately transmitted. The data can be used to know current hive conditions, know hive conditions over time, and/or predict future hive conditions and occurrences (e.g., swarms).

In the hive assembly 300, each of the components (e.g., the base 310, the boxes 320, 330, and the roof structure 340) has a transmitter/receiver; in other implementations, not all the components have a transmitter/receiver. In one example, only one component (e.g., the base 310) has a transmitter/receiver 351 so that data and information from all of the components is sent via that one component. Data from a component (e.g., the box 320) would be transmitted to the base 310 via the buses 314, 323 to be transmitted by the transmitter/receiver 351.

Via the transmitter(s), the hive assembly 300 is able to send raw data or analyzed data from the sensors regarding the temperature, humidity, bee count, frame weight, box weight, etc. to the beekeeper, such as to a computer program or cell phone “app.” The hive assembly 300 can be monitored through any web enabled device, application, or onsite through a main terminal, web enabled device or read out located on or near the hive. The monitoring allows onsite personal as well as offsite personal to access information on each hive's data, helping them make decisions to assist them in being as efficient as possible and have the least amount of stressors and impact on the bee colonies.

Via the receiver(s), the hive assembly 300 is able to receive remote commands to perform certain simple functions in the hive, such as, open/close dampers or vents, activate door actuators, feeders, light indicators, convenience lights, GPS antennas, and such.

The transmitter/receivers may operate on any or all of cell phone service (e.g., 4G, 5G), WiFi, Bluetooth, ZigBee, and the like to send data from the hive assembly to a remote location, e.g., to a computer, a cell phone, or other such device. The transmission may be short range, e.g., less than 50 feet, for example, to a beekeeper proximate the hive; such transmission may be by WiFi, Bluetooth, or ZigBee. Alternately, the transmission may be long range, e.g., greater than 50 feet, e.g., 5 miles, to a beekeeper remote from the hive; such transmission would be via cell tower service.

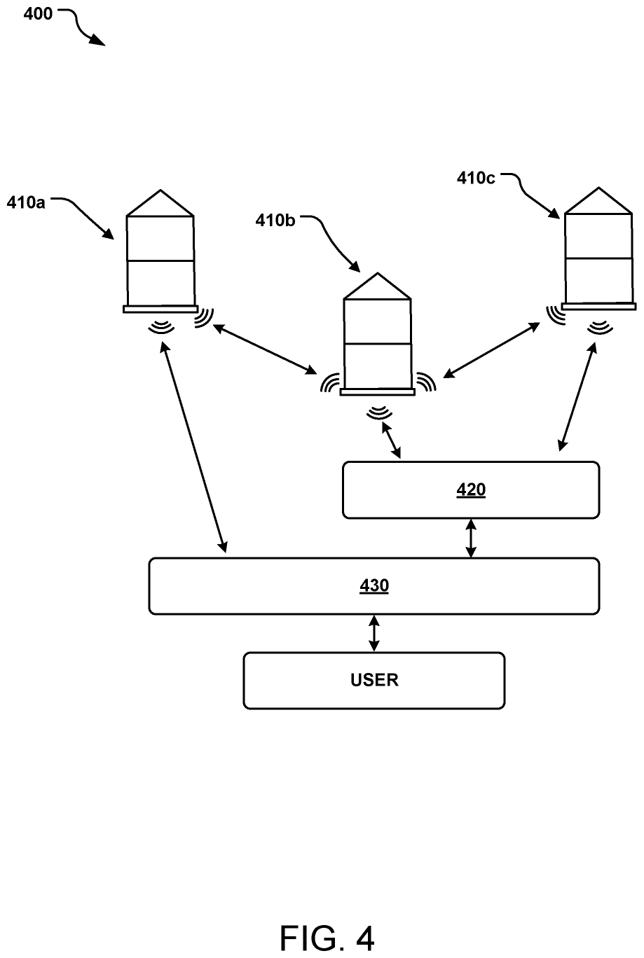

FIG. 4 illustrates a system 400 having three hive assemblies 410a, 410b, 410c each having at least one component (e.g., a base, a box, a roof structure) having integral therein monitoring components and a transmitter/receiver. The system 400 also includes a server 430.

The assemblies 410 (wirelessly) transmit their data, either as raw data or as analyzed data, to the server 430. In some systems 400, the assemblies 410 can transmit their data to a local network data collector 420, where it can be, e.g., stored in memory, analyzed, etc. In this system 400, the hive assemblies 410b and 410c transmit data to the data collector 420 which sends it to the server 430, whereas the assembly 410a sends data directly to the server 430.

In this system 400, the hive assemblies 410 are able to communication between themselves; FIG. 4 shows the hive assemblies 410a and 410b in communication and the hive assemblies 410b and 410c in communication. This feature may be used, for example, if one assembly is out of range of the data collector 420 and the server 430, that assembly then sends its data to an assembly that is in range; the in-range hive assembly acts as a transfer point.

The USER can access data regarding the assemblies 400 on the server 430, by using, e.g., a computer, a tablet, or a mobile device “app.” The USER can determine whether a change in the conditions of the hive is warranted, e.g., cool the hive by opening vents. The USER can send instructions to the desired hive assembly 410 via the server 430. In some implementations, the server 430 or even the hive assembly 410 itself may have a data analysis program that determines whether a change in hive conditions is warranted, thus avoiding the need for the USER to monitor the data. The server 430 or the hive assembly 410 itself may provide an instruction, e.g., to open a vent.

Overall, the various components of the beehive assembly, e.g., the base, the boxes, the roof, can have any or all of the following features:

Base:
1. insulated with thermal insulation on the bottom and on all or some sides to provide a minimum of R-1 rating or higher;
2. sensors at any location within base;
3. landing board formed from a material to facilitate visual detection of bees with a camera, video, or similar detection device, and to provide a backdrop for the image processing or detection of the bees, pests, or similar;
4. integrated bee counter and door mechanism to open and close from commands from but not limited to a microprocessor, microcontroller, energy storage, PLC, IOT, or microcomputer;
5. a gasket to provide airtight seal to adjacent boxes or devices; and
6. communication equipment to relay collected information to a data collector, internet, cellular network, or similar.

Boxes (Brood Boxes, Honey Supers, etc.)
1. made from a durable material on the exterior and interior of, plastic, wood, fiberglass, or other building materials;
2. any location for sensors in the insulated wall assemblies;
3. insulated with foam, foam board, fiberglass, or other insulating material obtaining a R value rating of 1 or higher;
4. wiring/buss, wiring harness and sensors embedded within the wall assemblies;
5. integrated load cells or similar for electronically measuring the weight of the entire hive, a box, or a frame;
6. connection plates or buses integrated into top and/or bottom to electrically connect adjoining boxes, bases, feeders, tops, or similar;
7. high speed camera or other detection device mounted on the end of the box and optionally molded into the side or within the frame;
8. camera or other bee detection device capable of detecting and distinguishing incoming traffic from outgoing traffic;
9. processing device for video camera; may also have image enhancing technology such as extra lights, inferred, FLIR, etc.;
10. recessed or surface mounted electronics containment apparatus that is weatherproof to house the microprocessor, microcomputer or similar;
11. embedded accelerometer, GPS device or other asset tracking device;
12. communication equipment to relay collected information to a data collector, internet, cellular network, or similar;
13. temperature (internal temperature and/or external temperature) and humidity sensor embedded within the wall assemblies;
14. carbon dioxide sensor, VOC sensor;
15. other digital or analog input and/or output sensors, controllers, lasers, detection devices or similar;
16. interior frame rest contains embedded electrical connections or similar to provide a continuity path for electrons or pulse signals to be delivered or received to or from the brood/honey frames for all sizes of frames;
17. energy storage and production devices embedded or attached to the box;
18. a gasket to inhibit air infiltration; and
19. radiant barrier on within wall cavity.

Cover/Roof Assembly:
1. insulation value at least R-4, or at least R-10;
2. any location for sensors in the roof assembly;
3. vents or louvers, with a servo for control;
4. power generator (e.g., solar panels, wind turbine), a charge controller, and/or a load controller, or similar, for generating power for the hive; and
5. radiant barrier in cover.

Frames:
1. frames for brood, honey, nectar, pollen, and similar can have an embedded wire or buss structure with exposed or recessed terminals for connection to boxes;
2. terminals and wiring/busing provide power, signal inputs or outputs to devices embedded or attached within the frames; and
3. a load cell may be included for each frame, e.g., to monitor the amount of honey in the frame.

There are numerous accessories for beehives and these integrated hive assemblies accommodate many types of accessories. Accessories that are stacked on or between boxes have a common connection between boxes with pressure type connections and that connect the buss or connection plate to provide communication between boxes as well as supply power. The accessories may also contain control devices and input devices capable of communicating to the microcontrollers, microprocessors or similar. The accessories may have the ability to communicate status through a screen or readout on the hive or displayed remotely via a modem system or similar.

Accessories:
1. connection via integrated buss and wiring within the wall assembly to attach to inputs or outputs;
2. stackable, with a gasket to inhibit air infiltration;
3. inner cover, feeder bins, queen excluders, pollen trap, propolis trap, etc.; and
4. GPS and/or accelerometer that actuates during a disturbance, e.g., to determine if a hive is being moved.

The accessories may have components from the monitoring system at any position. In one particular example design, a queen excluder can include a temperature sensor and humidity sensor at its center, to provide an indication of the conditions at the center of the hive.

The integrated hive assemblies of this disclosure can be deployed in any area that bee colonies can be managed. They are intended to be located where hives are capable of being placed and used by, but not limited to, beekeepers. The integrated hive assemblies can be monitored through any web enabled device, application, or onsite through a main terminal, web enabled device or read out located on or near the hive. The hive assemblies allow the beekeeper to reduce unnecessary hive inspections, saving them time and money. With the hyperthermia treatment available through the heating pad, they can help save some bees from Colony Collapse Disorder. With the option for many types of sensors and control devices in the wall assemblies, the hive assemblies have the ability to be flexible to the needs of the consumer and market challenges.

For over 100 years beekeepers have been using relatively the same types of equipment. With the advantages of technology, a beekeeper can now combine the advantages of electronics by electronically monitoring/controlling the hives while taking advantage of lightweight insulation that allows the integrating of controls, monitoring, energy storage, and others.

The above specification and examples provide a complete description of the structure and use of exemplary implementations of the invention. The above description provides specific implementations. It is to be understood that other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Spatially related terms, including but not limited to, “bottom,” “lower”, “top”, “upper”, “beneath”, “below”, “above”, “on top”, “on,” etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as below or beneath other elements would then be above or over those other elements.

What is claimed is:

1. An insulated beehive assembly comprising:
a base section,
at least one box, and
a roof section,
each of the base section, the at least one box, and the roof section stackable to provide the hive;
each of the base section, the at least one box, and the roof section having a wall assembly construction comprising walls and insulation between the walls, the wall assembly construction having an R-rating of at least 4;
a monitoring system within the wall assembly construction of at least one of the base section, the at least one box, and the roof section, the monitoring system comprising a humidity sensor, a temperature sensor, a wireless communication receiver and a wireless communication transmitter; and
a power source operably connected to the monitoring system.

2. The insulated beehive assembly of claim 1, wherein each of the base section, the at least one box, and the roof section has a humidity sensor and a temperature sensor.

3. The insulated beehive assembly of claim 1 further comprising a camera.

4. The insulated beehive assembly of claim 1, wherein each of the base section, the at least one box, and the roof section has a wireless communication receiver and a wireless communication transmitter.

5. The insulated beehive assembly of claim 1, further comprising wiring in each of the base section, the at least one box, and the roof section, the wiring in the base section connectable to the wiring in the at least one box, and the wiring in the least one box connectable to the wiring in the roof section.

6. The insulated beehive assembly of claim 1, wherein the base section and the at least one box has a gasket at the top of the wall assemblies.

7. The insulated beehive assembly of claim 1, wherein the roof section includes at least one vent.

8. The insulated beehive assembly of claim 7, wherein the vent is servo-actuated.

9. The insulated beehive assembly of claim 1, wherein the base section has a servo-actuated bee access.

10. The insulated beehive assembly of claim 1, wherein the base section has a first alignment feature and the at least one box has a second alignment feature configured to engage with the first alignment feature.

11. The insulated beehive assembly of claim 10, wherein one of the first alignment feature and the second alignment feature is a recess and the other of the first alignment feature and the second alignment feature is a tab.

12. The insulated beehive assembly of claim 1, wherein the wall assembly construction has an R-rating of at least 6.

13. The insulated beehive assembly of claim 1, further comprising a load cell or scale.

14. The insulated beehive assembly of claim 1, further comprising a heating board.

15. The insulated beehive assembly of claim 1, wherein the power source is a battery.

16. The insulated beehive assembly of claim 15, further comprising a solar panel on the roof section operably connected to the battery.

17. The insulated beehive assembly of claim 1, wherein the wireless communication receiver and the wireless communication transmitter are WiFi enabled, 4G enabled or 5G enabled.

18. The insulated beehive assembly of claim 1, further comprising a carbon dioxide sensor.

19. The insulated beehive assembly of claim 1, further comprising a GPS.
